(19) United States
(12) Patent Application Publication
(10) Pub. No.: US 2003/0030354 A1
(43) Pub. Date: Feb. 13, 2003

(54) Pipe-type lamp with cooling channels

(76) Inventor: Wun Fang Pan, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/925,463

(22) Filed: Aug. 10, 2001

(51) Int. Cl. H01J 1/02

(52) U.S. Cl. 313/46

(57) ABSTRACT

This invention relates to a pipe-type lamp with cooling channels, which are axially formed in the lamp when an outer tube covers the inner tube by extrusion molding. The cooling channel can provide fresh air flowing through to radiate heat produced by the bulb and to prevent the bulb from being overheated and broken.

### BACKGROUND OF INVENTION

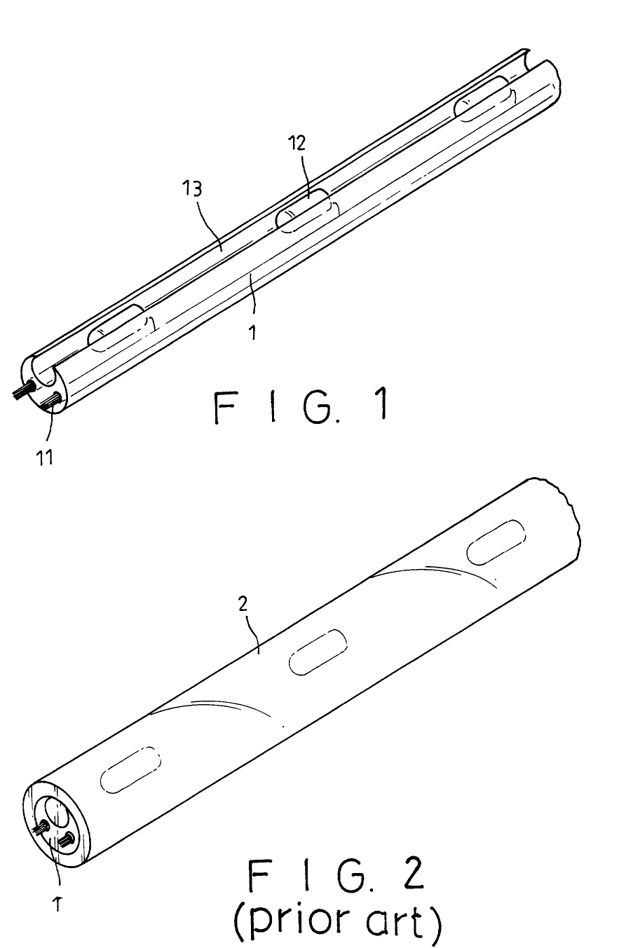

A conventional pipe-type lamp, as shown in FIGS. 1 and 2, includes an inner tube (1) connecting with electrical wires (11) and bulbs (12) and an outer tube (2) coating around the inner tube (1) by extrusion molding. When molding the outer tube (2) to cover the inner tube (1), a circular groove (13) on the inner tube (1) for receiving the bulbs (12) therein will be fulfilled by material being the same as the outer tube (2) in extruding. The finished pipe-type lamp will be a solid tube and the bulbs (12) are completely covered in the lamp. As the known lamp is used, heat produced by the bulbs (12) will not be easily radiated and the lamp is overheated while the bulb (12) is possibly burned out and destroyed.

Accordingly, the primary object of the invention is to provide a pipe-type lamp with cooling channels to utilize flowing air for radiating heat and protecting the bulb in the lamp. Now the features and advantages of the invention will be described in detail with reference to the accompanying drawings.

### BRIEF DESCRIPTION OF THE INVENTION

FIG. 1 is a perspective view showing an inner tube connecting with electrical wires and bulbs received in a circular groove thereon.

FIG. 2 is an assembled perspective view showing a prior pipe-type lamp.

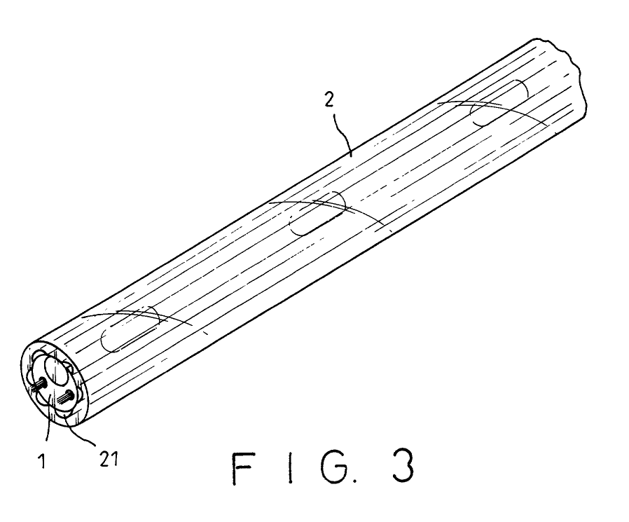

FIG. 3 is an assembled perspective view of a pipe-type lamp with cooling channels according to the present invention.

### DETAILED DESCRIPTION OF THE INVENTION

Please refer to FIGS. 1 and 3, the present invention includes a usual inner tube (1) with electrical wires (11) and bulbs (12) being received in a circular groove (13). A characteristic of the present invention is that several cooling channels (21) are formed axially in the lamp when an outer tube (2) is extrusion molding to cover the inner tube (1). In other words, the pipe-type lamp according to the present invention has several axial cooling channels in annular position. Moreover, the cooling channel (21) in this application is semi-circular and it will be understood that it can be any other shape, such as rectangular, triangular, and so on, which will be claimed in this application.

In use of the embodiment of this invention, the cooling channels (21) provide air flowing therethrough easily. When the lamp is used, heat produced by the bulbs (12) can be removed by flowing air. The pipe-type lamp obtains a better cooling effect and overcomes the drawback of a prior one.

Accordingly, the invention obtains an obvious improvement. It meets the requirements of granting a patent. We hereby file an application for a patent grant.

What is claimed is:

1. A pipe-type lamp with cooling channels including an inner tube connecting with electrical wires and bulbs and being covered by extrusion molding an outer tube, and a characteristic is that several axial cooling channels are formed in the pipe-type lamp for providing fresh air flowing through easily to radiating heat produced by the bulbs.
